(19) United States
(12) Patent Application Publication
(10) Pub. No.: US 2007/0180786 A1
(43) Pub. Date: Aug. 9, 2007

(54) Hollow vinyl screen/storm door

(76) Inventor: Ben Sotuyo, Columbia, MD (US)

Correspondence Address: JAMES RAY & ASSOCIATES, 2640 Pitcairn Road, Monroeville, PA, 15146, US

(21) Appl. No.: 11/489,659

(22) Filed: Jul. 19, 2006

Related U.S. Application Data
(60) Provisional application No. 60/700,681, filed on Jul. 19, 2005.

(51) Int. Cl. E06B 3/72

(52) U.S. Cl. 52/456; 52/656.7

(57) ABSTRACT

A substantially rectangular hollow door for use as one of a screen door and a storm door, the substantially rectangular hollow door comprises a pair of stiles, each stile of the pair of stiles having a first end and a second end. There are a pair of rails. A top rail is disposed closely adjacent and connected to the first end of the pair of stiles and a bottom rail is disposed closely adjacent and connected to the second end of the pair of stiles thereby forming the substantially rectangular door. A center rail is disposed at substantially a midpoint of the top and the bottom rail. Such center rail is engagable with the first and the second stile and a vertical member is disposed between the center rail and the bottom rail, such vertical member disposed at substantially a midpoint of center rail and bottom rail.

### FIELD OF THE INVENTION

The present invention relates, in general, to a screen/storm door, and, more specifically the present invention relates to a hollow vinyl screen/storm door having unique securing features and anti-warping characteristics.

### BACKGROUND OF THE INVENTION

A multitude of modular and composite thermally insulated door structures are known incorporating therein various compositions of materials primarily to provide a thermal barrier. When such doors have incorporated therein glass windows or thin panels, their structure is somewhat weakened and this will often cause the door to warp, and cause improper closing thereby causing air and water to infiltrate. U.S. Pat. No. 4,327,535 discloses the construction of a composite steel door incorporating a pane of glass which is surrounded by a mitered wooden frame and an interior foam core is disposed within opposed metal skins of the door. A top and bottom rail interlocks with the lock and hinge stiles which are fabricated of wooded boards. With this door structure the metal skins are secured to the stiles and rails, but there is no structural rigidity in between the stiles and rails, and the door is subject to warping along its longitudinal plane. A problem with using exposed indoor structures is that the steel will oxidate resulting in rust.

Also, some door structures do not provide good insulation due to the fact that they utilize metal skins which are heat conductors and these skins contract and expand causing air and water leaks in areas where it is fastened or at joints. It has now become customary to fabricate outside doors with plastic extruded material secured to wooden stiles and wherein a foam insulating material is injected within the door cavities. Such construction is, for example, illustrated in U.S. Pat. No. 5,074,087. A disadvantage of such door structures is that they exhibit weakness, particularly in the area where panels or glass panes are provided, and the door does not have rigidity in its longitudinal plane. Therefore, the door is apt to distort when the plastics material is subjected to heat and cold weather.

### OBJECTS OF THE INVENTION

It is, therefore, one of the primary objects of the present invention to provide a hollow vinyl screen/storm door that will not warp.

Another object of the present invention is to provide a hollow vinyl screen/storm door

Yet, another object of the present invention is to provide a hollow vinyl screen/storm door

Still another object of the present invention is to provide a hollow vinyl screen/storm door

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a planer view of the screen/storm door according to an embodiment of the invention.

FIG. 2 is a planer view of the screen/storm door according to an alternate embodiment of the invention.

FIG. 3A is cross sectional view of a portion of a stile showing an embodiment of the invention.

FIG. 3B is a cross sectional view of a portion of a stile according to an alternate embodiment of the invention.

FIG. 4A is cross sectional view of a portion of a stile showing a different embodiment of the invention.

FIG. 4B is a cross sectional view of a portion of a stile according to yet another embodiment of the invention.

FIG. 5 is a partial perspective view of a screen/storm door.

FIG. 6 is a cross sectional view of a portion of a stile according to a different embodiment.

FIG. 7 is a cross sectional view of a portion of a stile according to an alternate embodiment.

FIG. 8 is a partial perspective view of a portion of a screen/storm door showing the union between a center stile and a rail.

FIG. 9 is a partial perspective view of a portion of a screen/storm door showing the union between a stile and a rail.

FIG. 10 is a partial perspective view of a portion of a screen/storm door showing the union between a stile and a rail according to a different embodiment.

FIG. 11 is a planer view of a portion of a screen/storm door.

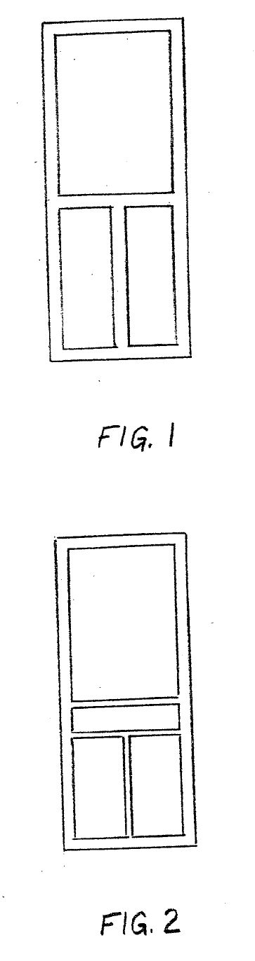

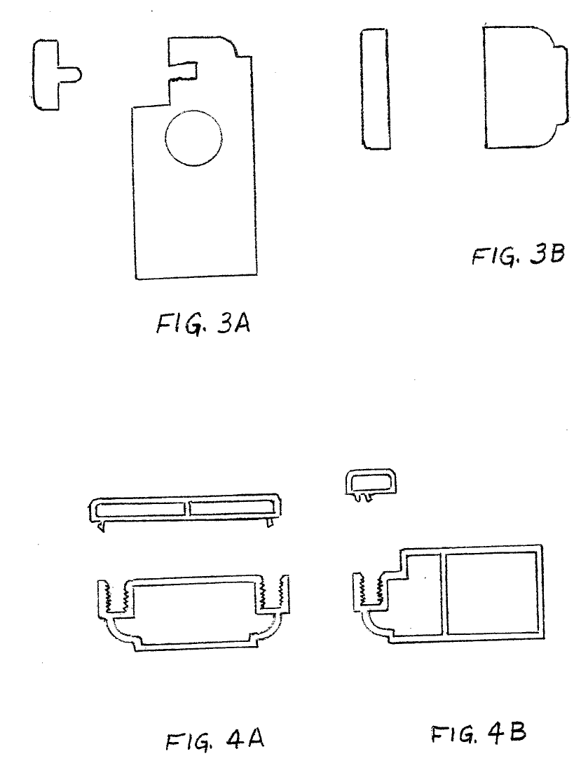

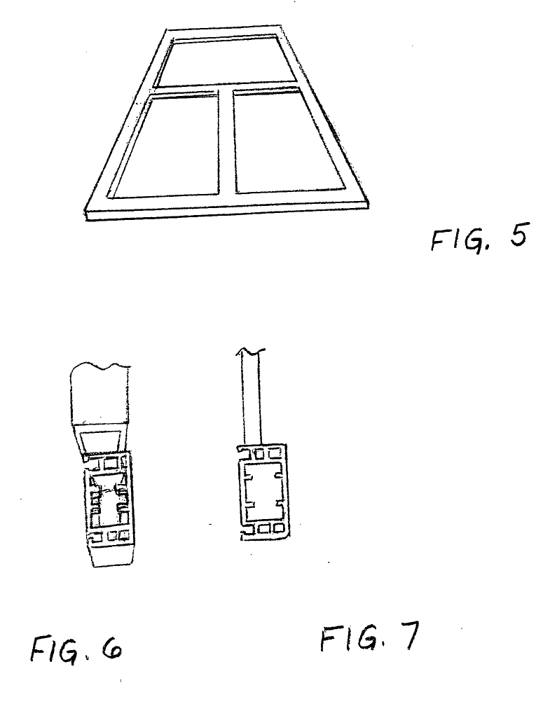

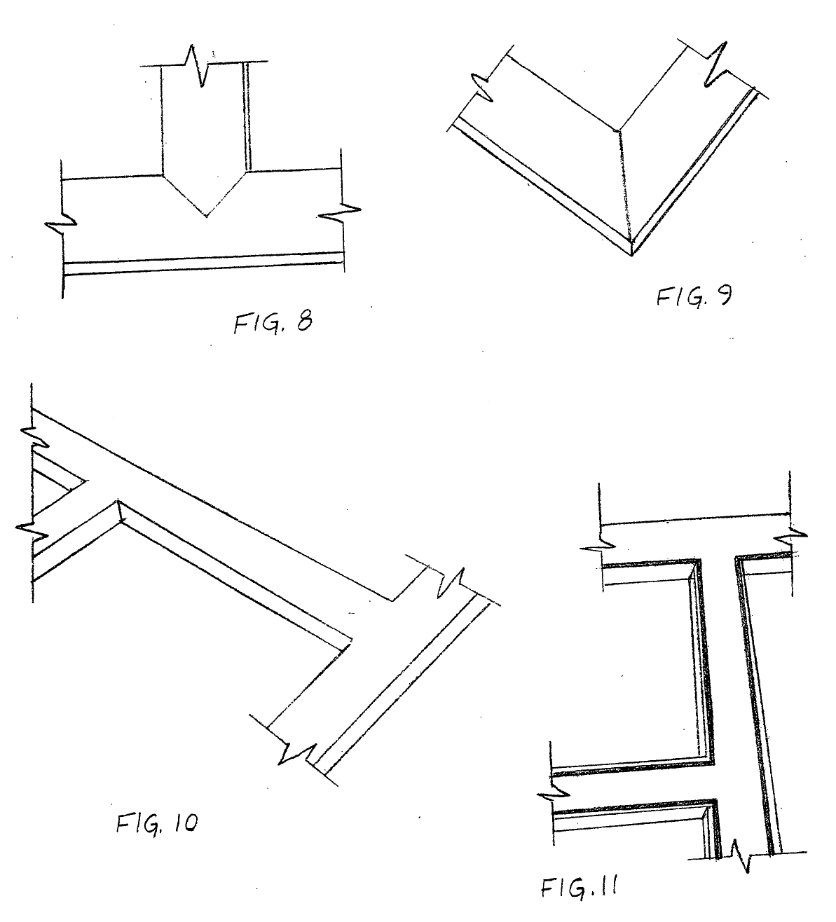

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

The present invention provides a variety of embodiments in the formation of a hollow vinyl screen/storm door with different securing means and with anti-warping characteristics.

The door of the present invention is provided with a pair of stiles and rails forming the substantially rectangular door. There is a center rail disposed at substantially a midpoint between the top and bottom rails and a vertical member disposed between the center rail and the bottom rail.

An alternate embodiment of the invention provides a door with a pair of stiles and a pair of rails forming the substantially rectangular door. This embodiment provides a pair spaced apart center rails with a vertical member disposed between the lower center rail and the bottom rail.

In the preferred embodiment of the invention such juncture between the rails and the stiles are formed with mitered joints.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

I claim:

1. A substantially rectangular hollow door for use as one of a screen door and a storm door, said substantially rectangular hollow door comprising:
(a) a pair of stiles, each stile of said pair of stiles having a first end and a second end;
(b) a pair of rails, a top rail disposed closely adjacent and connected to said first end of said pair of stiles and a bottom rail disposed closely adjacent and connected to said second end of said pair of stiles thereby forming said substantially rectangular door;
(c) a center rail disposed at substantially a midpoint of said top and said bottom rail, said center rail engagable with said first and said second stile;
(d) a vertical member disposed between said center rail and said bottom rail, said vertical member disposed at substantially a midpoint of said center rail and said bottom rail.
